(19) United States
(12) Patent Application Publication
(10) Pub. No.: US 2025/0019783 A1
(43) Pub. Date: Jan. 16, 2025

(54) PROCESS AND SYSTEM FOR AUSTEMPERING METAL WORKPIECES

(71) Applicant: ALD Vacuum Technologies GmbH, Hanau (DE)

(72) Inventors: Volker HEUER, Frankfurt a.M. (DE); Gunther SCHMITT, Hanau (DE); Robin VIEL, Erlensee (DE)

(73) Assignee: ALD Vacuum Technologies GmbH, Hanau (DE)

(21) Appl. No.: 18/712,478

(22) PCT Filed: Nov. 24, 2022
(86) PCT No.: PCT/EP2022/083200

§ 371 Date: May 22, 2024

(30) Foreign Application Priority Data
Nov. 25, 2021 (DE) 10 2021 130 969.7

(51) Int. Cl. C21D 1/18; C21D 1/34; C21D 1/613; C21D 9/00; C21D 11/00

(52) U.S. Cl. CPC C21D 1/18; C21D 1/34; C21D 1/613; C21D 9/0062; C21D 11/00

(57) ABSTRACT

In a process and an apparatus for austempering, metal workpieces and optional tempering bodies are quenched in a quenching volume V of a quenching apparatus, in which the quenching volume V is flowed through by a cooling fluid, and the workpieces are tempered by thermal radiation of the tempering bodies, by thermal radiation of one or more heating elements arranged in the quenching apparatus, or by a thermal fluid in such a way that an average temperature T(t) of the workpieces follows a progression over time according to the relationship

$$T ( t ) = {T}_{0} + {T}_{1} [ 1 + tanh ( - \frac{t}{τ} ) ]$$

where t is the time in seconds, 150° C.≤T₀≤250° C., 600° C.≤T₁≤820° C., 12 s≤τ≤24 s, 0 s≤t≤Γ and 180 s≤Γ≤240 s.

The present invention relates to a method and to a system for austempering of metallic workpieces or components, wherein the workpieces are austenitized in a furnace and then cooled and tempered in a quench chamber by allowing a cooling fluid to flow through according to a precisely defined time-temperature profile.

Austempering reduces intrinsic stresses and increases the toughness of steels. Austempering is found to be extremely advantageous for steels that are susceptible to cracking and complex-shaped components. Bainite (also known in German by a term meaning “intermediate microstructure”) is a metallurgical microstructure that can be formed in the heat treatment of carbonaceous steel by isothermal transformation or continuous cooling. Bainite is formed at temperatures and cooling rates between those for pearlite and martensite. Unlike in the case of martensite, lattice shear processes in the crystal lattice and diffusion processes are coupled and various transformation mechanisms are involved in bainite formation. The bainite microstructure varies depending on cooling rate, carbon content and alloy elements. Just like pearlite, bainite consists of the ferrite and cementite (Fe₃C) phases. However, bainite differs from pearlite by the shape, size and distribution of the crystalline domains. Bainite microstructures are divided into two main classes:
“upper bainite” (or “grainy bainite”); and
“lower bainite”.

For austempering, steel is first austenitized and then quenched to temperatures above the martensite start temperature M_{S}. The cooling rate here is chosen such that no transformation to the pearlite stage can take place. When held at a temperature above M_{S}, austenite is largely transformed to bainite. Lattice shear processes proceeding from grain boundaries or defects transform austenite gradually to carbon-supersaturated ferrite crystals with a cubic body-centered lattice (bcc lattice). In lower bainite, carbon forms spheroidal precipitates in the ferrite grain owing to an elevated diffusion rate in the bcc lattice. In the case of upper bainite, the carbon can diffuse into austenite regions and form carbides there. Upper bainite is formed at higher austempering temperatures and has an acicular microstructure similar to that of martensite. The carbon is preferably precipitated here at the grain boundaries of the ferrite needles. In upper bainite, irregular and dislocated cementite crystals are formed, the statistical distribution of which imparts a granular appearance to the microstructure. On cursory metallurgical analysis, the microstructure of upper bainite can be confused with pearlite or the Widmanstätten microstructure. Lower formed on bainite is isothermal continuous cooling with low austempering temperature. Ferrite formation results in enrichment of carbon in the austenite and, as cooling progresses, austenite is transformed to ferrite, cementite, acicular bainite and martensite.

Methods of austempering metallic workpieces are known in the art. WO 2001/049888 A1 describes an austempering method in which the workpieces are austenitized, quenched in a first salt bath or oil bath and tempered in a second salt bath or oil bath.

The methods described in the art, for the quenching of workpieces, use salt baths or oil baths, which are costly and inconvenient in terms of plant and process engineering;
cause a cooling rate that varies significantly at the workpiece surface owing to bubble formation in the quench bath;
do not allow measurement and closed-loop control of the temperature of the workpieces in the course of quenching;
form residues on the workpieces which require intensive cleaning; and
pollute the environment.

The present invention has for its object to provide a method and a system for austempering that overcome the disadvantages detailed above and are notable for:
precise control of workpiece temperature;
reduced energy consumption; and
an efficient, largely automated method.

The first object of the invention is achieved by a method of austempering metallic workpieces, comprising the steps of:
arranging the workpieces on a batch carrier;
optionally arranging one or more tempering bodies on the batch carrier;
optionally arranging a metallic reference body on the batch carrier;
thermally or thermochemically treating the workpieces arranged on the batch carrier and optionally the tempering bodies and/or the reference body, where the workpieces are heated to a temperature of 750 to 1100° C.;
arranging the batch carrier together with the workpieces and optionally the tempering bodies and/or the reference body in a quench volume V of a quench apparatus;
quenching the workpieces and optionally the tempering bodies and/or the reference body, where
(a) a cooling fluid is allowed to flow through the quench volume V, and
(b) the workpieces are tempered
   with thermal radiation from the tempering bodies,
   with radiation from one or more heating elements disposed in the quench apparatus, or
   with a heating fluid;
      wherein an average temperature T(t) of the workpieces has a progression against time according to the relationship

$$T ( t ) = {T}_{0} + {T}_{1} [ 1 + tanh ( - \frac{t}{τ} ) ]$$

where t denotes time in seconds, 150° C.≤T₀≤250° C., 600° C.≤T₁≤820° C., 12 s≤τ≤24 s, 0 s≤t≤Γ and 180 s≤Γ≤240 s.

Appropriate embodiments of the method of the invention are characterized by the further features that follow in any combination, provided that the combined features are not contradictory, and according to which:
during the quenching of the workpieces, an average temperature T(t) of the workpieces has a progression against time according to the relationship

$$T ( t ) = {T}_{0} + {T}_{1} [ 1 + tanh ( - \frac{t}{τ} ) ]$$

where t denotes time in seconds, 150° C.≤T₀≤250° C., 600° C.≤T₁≤820° C., 12 s≤τ≤24, 0 s≤t≤Γ and 180 s≤Γ≤240 s;
the cooling fluid used is air, nitrogen, helium or hydrogen;
a pressure of the cooling fluid in the quench volume V is 2 to 20 bar;
the heat fluid used is steam at a temperature of 150 to 250° C.;
the heat fluid used is air at a temperature of 150 to 600° C.;
an average temperature T(t) of the workpieces is measured during quenching;
a temperature of the reference body is measured during quenching;
the volume flow rate (m³/s) of the cooling fluid through the quench volume V is subject to electronic closed-loop control;
the power (kW) of the at least one heating element is subject to electronic closed-loop control;
the at least one heating element takes the form of an infrared lamp;
the at least one heating element comprises an infrared lamp and a reflector;
the at least one heating element takes the form of an infrared lamp with an integrated reflector;
the at least one heating element comprises an infrared lamp and an external reflector;
the at least one heating element consists of a metallic material, graphite or carbon fiber-reinforced graphite (CFC);
the at least one heating element takes the form of a cylindrical rod;
the at least one heating element takes the form of a cuboidal rod;
the at least one heating element takes the form of a meandering body with round or rectangular cross section;
the volume flow rate (m³/s) of the heat fluid into the quench volume V is subject to electronic closed-loop control; and/or
the quench volume V has a size of 0.03 to 1 m³ (0.03 m³≤V≤1.0 m³).

The second object of the invention is achieved by a system of austempering metallic workpieces, comprising:
one or more batch carriers for the storage of workpieces;
optionally one or more tempering bodies composed of a metallic material, graphite or carbon fiber-reinforced graphite (CFC);
optionally a reference body composed of a metallic material;
a furnace for the thermal or thermochemical treatment of workpieces disposed on one or more batch carriers and optionally tempering bodies and/or the reference body, where the furnace is designed and set up to heat the workpieces up to a temperature of 750 to 1100° C.; and
a quench apparatus comprising
   a quench chamber having a quench volume V for accommodation of one or more batch carriers comprising workpieces and optionally tempering bodies and/or the reference body;
   a vessel for cooling fluid and a fluid drive controllable by electronic closed-loop control for the flow of cooling fluid through the quench volume V;
   one or more temperature sensors for the measurement of a temperature T(t) of the workpieces or a temperature of the reference body;
   optionally one or more heating elements controllable by electronic closed-loop control;
   optionally an electrically heatable vessel for a heat fluid and a valve controllable by electronic closed-loop control and/or a flow drive controllable by electronic closed-loop control for the charging of the workpieces with heat fluid; and
   an electronic controller having a control program, where the fluid drive for the cooling fluid, the temperature sensors, the optional heating elements, the optional valve and the optional flow drive for the heat fluid are connected to the electronic controller;
      wherein the quench apparatus is designed and set up to cool down the workpieces such that an average temperature T(t) of the workpieces has a progression against time according to the relationship

$$T ( t ) = {T}_{0} + {T}_{1} [ 1 + tanh ( - \frac{t}{τ} ) ]$$

where t denotes time in seconds, 150° C.≤T₀≤250° C., 600° C.≤T₁≤820° C., 12 s≤τ≤24 s, 0 s≤t≤Γ and 180 s≤Γ≤240 s.

Appropriate embodiments of the system of the invention are characterized by the following further features in any combination, provided that the combined features are not contradictory, and according to which:
the system comprises one or more tempering bodies and the at least one tempering body
   takes the form of a cylinder or cuboid;
   takes the form of a tube having a circular or rectangular opening cross section;
   takes the form of a tube having a circular or rectangular opening cross section and comprises a plurality of multiple movable dividing walls;
   takes the form of a box having a multitude of compartments in shaft form for the accommodation of workpieces; or
   takes the form of a box having a base plate and four side walls and comprises multiple movable dividing walls;
the system comprises one or more tempering bodies and the at least one tempering body
   takes the form of a plate having apertures for accommodation of workpieces; or
   takes the form of a plate having depressions for accommodation of workpieces;
the system comprises one or more tempering bodies and the at least one tempering body
   takes the form of a plate having apertures for accommodation of workpieces, where the apertures each have a circular or hexagonal outline; or
   takes the form of a plate having depressions for accommodation of workpieces, where the depressions each have a circular or hexagonal outline;
the system comprises one or more tempering bodies and the at least one tempering body
   takes the form of a plate having apertures for accommodation of workpieces, where the plate has a thickness of 20 mm to 200 mm and laterally has an outline that can be described by a rectangle having a width of 200 mm to 1200 mm and a length of 200 mm to 1200 mm; or
   takes the form of a plate having depressions for accommodation of workpieces, where the plate has a thickness of 20 mm to 200 mm and laterally has an outline that can be described by a rectangle having a width of 200 mm to 1200 mm and a length of 200 mm to 1200 mm;
the system comprises one or more tempering bodies and the at least one tempering body
   takes the form of a plate having apertures for accommodation of workpieces, where the apertures are arranged relatively to one another in the manner of a lateral hexagonal lattice and are separated from one another by lands; or
   takes the form of a plate having depressions for accommodation of workpieces, where the depressions are arranged relatively to one another in the manner of a lateral hexagonal lattice and are separated from one another by lands;
the batch carrier takes the form of a grid and consists of graphite or carbon fiber-reinforced graphite (CFC);
the at least one heating element takes the form of an infrared lamp;
the at least one heating element comprises an infrared lamp and a reflector;
the at least one heating element takes the form of an infrared lamp with an integrated reflector;
the at least one heating element comprises an infrared lamp and an external reflector;
the at least one heating element consists of a metallic material, graphite or carbon fiber-reinforced graphite (CFC);
the at least one heating element takes the form of a cylindrical rod;
the at least one heating element takes the form of a cuboidal rod;
the at least one heating element takes the form of a meandering body with round or rectangular cross section;
the fluid drive for the cooling fluid takes the form of a fan;
the fluid drive for the cooling fluid takes the form of a turbine;
the flow drive for the heat fluid takes the form of a fan;
the flow drive for the heat fluid takes the form of a turbine;
the flow drive for the heat fluid takes the form of a pump;
the quench apparatus is equipped with an infrared sensor or pyrometer and a viewing field of the infrared sensor covers a defined region of the quench volume V;
the quench apparatus is equipped with an infrared sensor, a viewing field of the infrared sensor covers a defined region of the quench volume V, and one or more batch carriers disposed in the quench apparatus are partly or completely within the region;
the quench apparatus is equipped with an infrared sensor and a viewing field of the infrared sensor covers a defined region of the quench volume V and a batch carrier disposed therein;
the quench apparatus is equipped with an infrared sensor for measurement of a temperature of the workpieces;
the quench apparatus is equipped with an infrared sensor for measurement of a temperature of the reference body;
the quench apparatus is equipped with an infrared camera for measurement of the temperature of the workpieces;
the control program is designed and set up to control the fluid drive for the cooling fluid depending on an average temperature of the workpieces or a temperature of the reference body according to a closed-loop control algorithm;
the control program is designed and set up to control the heating elements depending on an average temperature of the workpieces or a temperature of the reference body according to a closed-loop control algorithm;
the control program is designed and set up to control the valve and/or the flow drive for the heat fluid depending on an average temperature of the workpieces or a temperature of the reference body according to a closed-loop control algorithm;
the quench volume V has a size of 0.03 to 1 m³ (0.03 m³≤V≤1.0 m³);
the quench apparatus comprises one or more infrared reflectors;
the quench apparatus comprises 2, 3, 4, 5, 6, 7, 8, 9, 10, 11, 12 or more infrared reflectors;
the quench apparatus comprises one or more infrared reflectors, and 12 to 90% of a surface area of the quench volume is covered by the at least one infrared reflector;
12 to 90% of an internal surface area of a wall of the quench chamber is lined with infrared reflectors;
the quench apparatus comprises one or more infrared reflectors, where at least one surface of the infrared reflectors has an emission level ε with 0≤ε≤0.1 measured according to DIN EN 12898:2019-06;
the quench apparatus comprises one or more infrared reflectors, where at least one surface of the infrared reflectors has an emission level ε with 0≤ε≤0.06 or 0.04≤ε≤0.1 measured according to DIN EN 12898:2019-06;
the quench apparatus comprises one or more infrared reflectors, where at least one surface of the infrared reflectors has an emission level ε with 0≤ε≤0.02, 0.01≤ε≤0.03, 0.02≤ε≤0.04, 0.03≤ε≤0.05, 0.04≤ε≤0.06, 0.05≤ε≤0.07, 0.06≤ε≤0.08, 0.07≤ε≤0.09 or 0.08≤ε≤0.1 measured according to DIN EN 12898:2019-06;
the quench apparatus comprises one 4 more infrared reflectors consisting of coated glass;
the quench apparatus comprises one or more infrared reflectors consisting of glass modified with a multilayer sputter coating comprising a seed layer of zinc oxide (ZnO) and a layer of silver (Ag) deposited thereon;
the quench apparatus comprises one or more infrared reflectors consisting of glass modified with a multilayer sputter coating comprising two seed layers of zinc oxide (ZnO) and two layers of silver (Ag) each deposited on one of the ZnO seed layers;
the quench apparatus comprises one or more infrared reflectors consisting of glass modified with a multilayer sputter coating comprising three seed layers of zinc oxide (ZnO) and three layers of silver (Ag) each deposited on one of the ZnO seed layers;
the quench apparatus comprises one or more infrared reflectors, where each infrared reflector consists of an aluminum plate;
the quench apparatus comprises one or more infrared reflectors, where each infrared reflector consists of an aluminum plate having a thickness of 0.5 to 5 mm;
the quench apparatus comprises one or more infrared reflectors, where each infrared reflector consists of an aluminum plate having a thickness of 0.5 to 2.5 mm or 2.0 to 5.0 mm;
the quench apparatus comprises one or more infrared reflectors, where each infrared reflector consists of an aluminum plate having a thickness of 0.5 to 1.5 mm, 1.0 to 2.0 mm, 1.5 to 2.5 mm, 2.0 to 3.0 mm, 2.5 to 3.5 mm, 3.0 to 4.0 mm, 3.5 to 4.5 mm or 0.5 to 1.5 mm;
the quench apparatus comprises one or more infrared reflectors, where each infrared reflector is modified with aluminum foil;
the quench apparatus comprises one or more infrared reflectors, where each infrared reflector comprises a carrier plate coated with aluminum foil;
an internal surface of a wall of the quench chamber is equipped with mounts for one or more infrared reflectors;
an internal surface of a wall of the quench chamber is equipped with mounts for one or more infrared reflectors and the mounts have grooves;
an internal surface of a wall of the quench chamber is equipped with pairs of mounts for one or more infrared reflectors, where two paired mounts comprise two mutually opposing grooves;
the system comprises a transfer chamber, where the transfer chamber is designed and configured to transfer one or more batch carriers with workpieces disposed thereon and optionally tempering bodies and/or a reference body from the furnace to the quench apparatus;
the system comprises a transfer chamber, where the transfer chamber comprises a transport apparatus designed and configured to transfer one or more batch carriers with workpieces disposed thereon and optionally tempering bodies and/or a reference body from the furnace to the quench apparatus;
the system comprises a transfer chamber, where the transfer chamber comprises an electrical heater designed and configured to heat an internal surface of the transfer chamber up to a temperature of 100° C. to 500° C.;
the system comprises a transfer chamber and a first and second closure device, and the first closure device connects the furnace to the transfer chamber and the second closure device the quench apparatus to the transfer chamber;
the transfer chamber and the first and second closure device are designed and set up to transport one or more batch carriers with workpieces disposed thereon from the furnace into the transfer chamber and to alter an atmospheric pressure that exists in the furnace by a differential pressure DA with 0≤D_{Δ}≤200 mbar or −200 mbar≤D_{Δ}≤0;
the first and second closure device take the form of gastight doors;
the first and second closure device take the form of gastight sliders;
the system comprises a transport apparatus designed and set up to remove one or more batch carriers with workpieces disposed thereon from the furnace and to transfer them into the quench apparatus; and/or
the system comprises a transport apparatus designed and set up to remove one or more batch carriers with workpieces disposed thereon and optionally tempering bodies and/or a reference body from the furnace and to transfer them into the quench apparatus.

The invention enables austempering of metallic workpieces in a precisely controlled, efficient and environmentally friendly manner.

In the present invention, the term “quench volume” refers to a spatial region surrounded by a quench chamber of the quench apparatus, where the “quench volume” may be smaller than or equal to a spatial region delimited by the quench chamber. The term “quench volume” relates not to a physically delimited entity but to a spatial region sufficiently large to accommodate one or more batch carriers with workpieces disposed thereon. According to the invention, the “quench volume” has the shape of a cuboid or cylinder.

The invention is elucidated in detail hereinafter on the basis of schematic drawings.

The figures show:

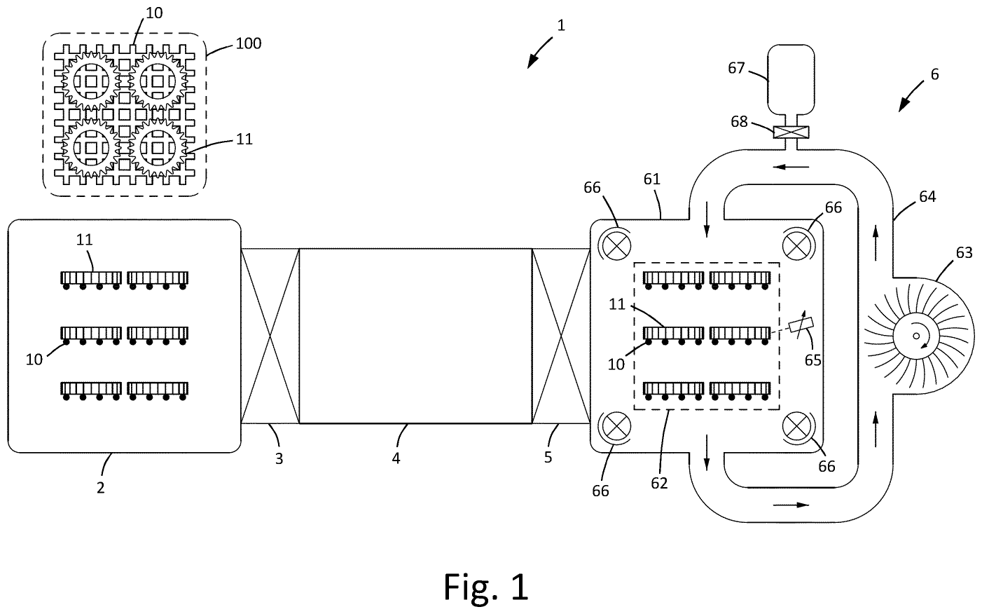

FIG. 1 a system for the austempering of metallic workpieces;

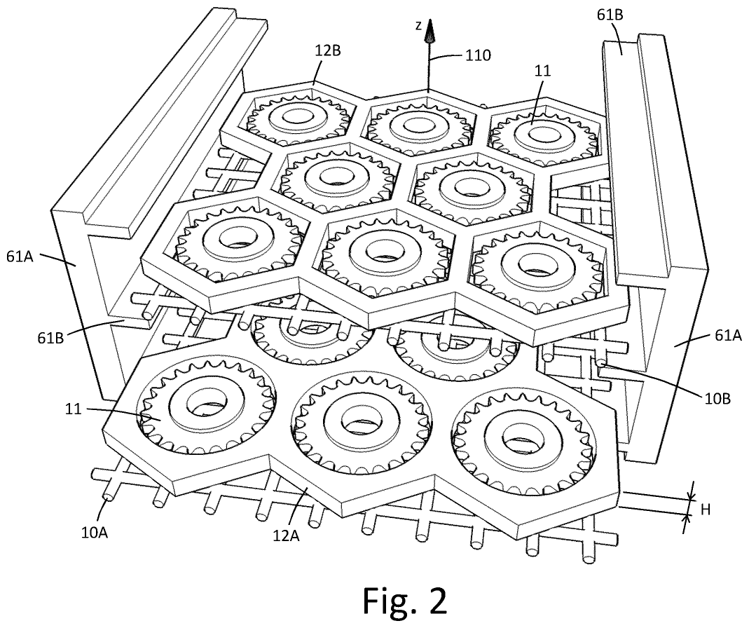

FIG. 2 a partial perspective view of a quench apparatus with workpieces and tempering bodies disposed therein;

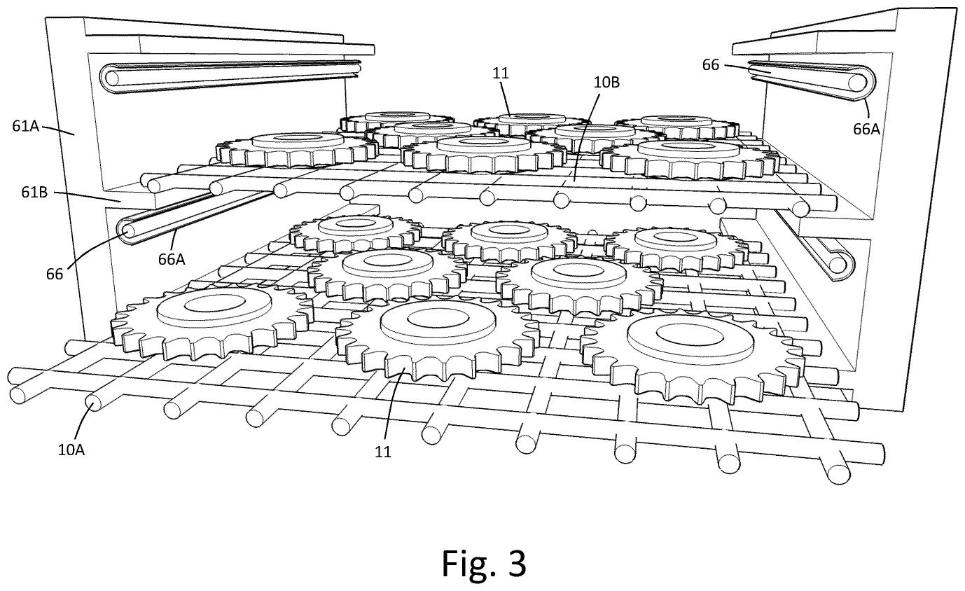

FIG. 3 a partial perspective view of a quench apparatus equipped with infrared lamps and workpieces disposed therein;

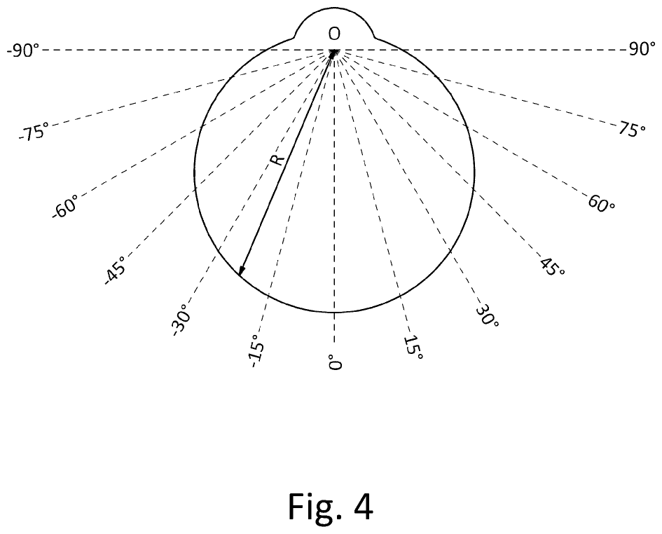

FIG. 4 a directional characteristic of an infrared lamp;

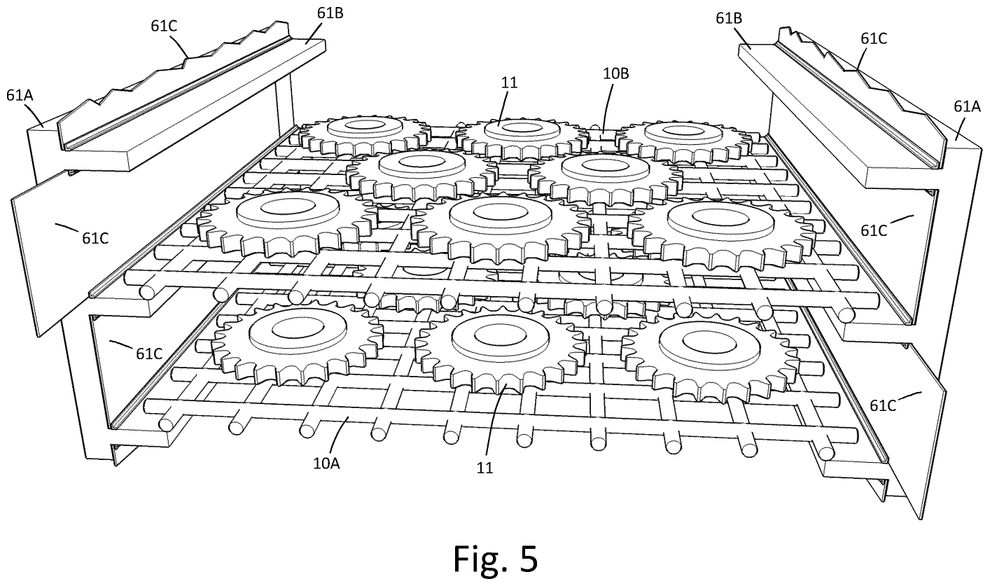

FIG. 5 a partial perspective view of a quench apparatus equipped with infrared reflectors;

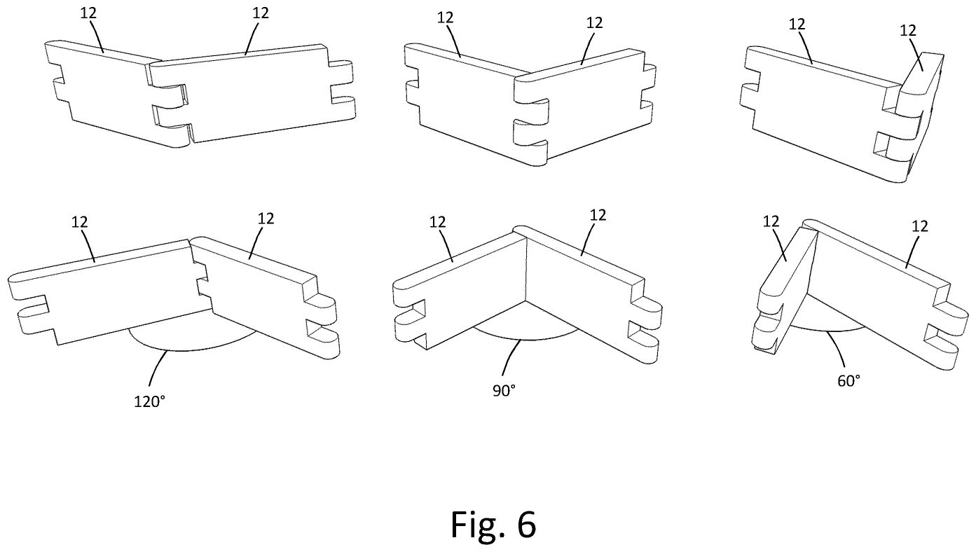

FIG. 6, 7 tempering bodies of various shape;

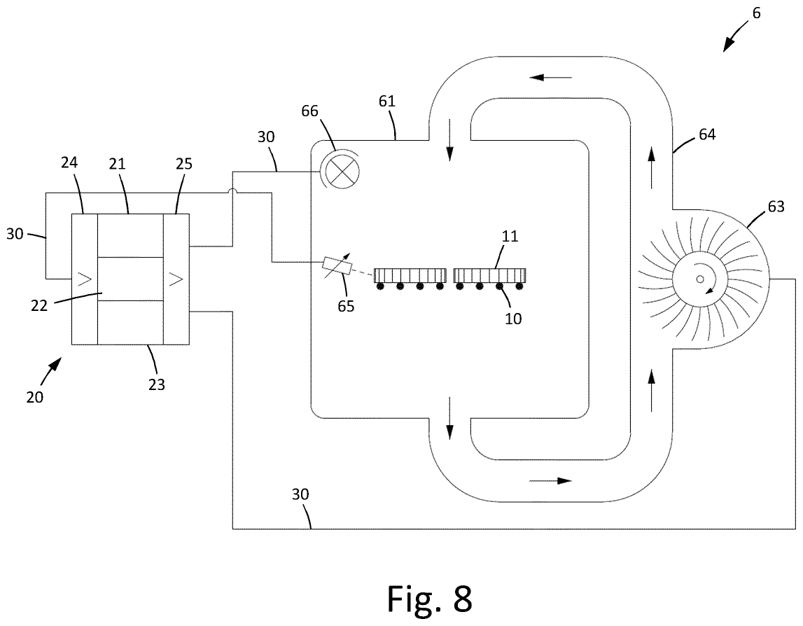

FIG. 8 a block diagram of a controller with sensors and components controllable by closed-loop control.

FIG. 1 shows a schematic of an inventive system 1 for the austempering of metallic workpieces 11 disposed on one or more batch carriers 10. The insert 100 framed by a dotted line in FIG. 1 serves for illustration and shows a top view of a batch carrier 10 with four workpieces 11. The workpieces 11 are, for example, steel ring gears. In an appropriate embodiment of the invention, the batch carrier 10 takes the form of a grid and consists of a material such as graphite, carbon fiber-reinforced graphite (CFC) or a metallic material.

The system 1 comprises at least one furnace 2 for the thermal or thermochemical treatment of the workpieces 11. The furnace 2 is designed and set up to heat the workpieces 11 up to a temperature of 750 to 1100° C. In appropriate embodiments of the invention, the furnace 2 is additionally designed and set up to perform the following operations on the workpieces 11 under standard pressure (0.9 to 1.1 atm) or low pressure (0 to 200 mbar):
carburization;
nitriding;
carbonitriding;
contacting with a carbonaceous donor gas containing acetylene (C₂H₂) for example;
contacting with a nitrogenous donor gas containing ammonia (NH₃) or nitrogen (N₂) for example; or
contacting with a partially ionized gas atmosphere and nitriding especially under plasma excitation.

Immediately after a thermal or thermochemical treatment, the batch carriers 10 together with the workpieces 11 are transferred from the furnace 2 into a quench volume 62—also referred to in the context of the invention as “quench volume V”—of a quench apparatus 6. In an appropriate embodiment of the system 1, the furnace 2 and the quench apparatus 6 are connected to one another via first and second closure devices (3, 5) and a transfer chamber 4 disposed between the first and second closure device (3, 5). The closure devices (3, 5) and the transfer chamber 4 function as a lock and permit removal of the batch carriers 11 together with the workpieces 10 from the furnace 2 without noticeably influencing a gas atmosphere in the furnace 2. In the context of the invention, embodiments are additionally provided in which, rather than the closure devices (3, 5) and the transfer chamber 4, conventional handling equipment, industrial robots or driverless transport systems (AGVs, i.e. automated guided vehicles) are used.

The quench apparatus 6 comprises a quench chamber 61 surrounding the quench volume 62, a recirculation conduit 64 connected to the quench chamber 62, and a fan or a turbine 63.

The fan or the turbine 63 and the recirculation conduit 64 are designed and set up for a cooling fluid to flow through the quench volume 62. The cooling fluid is retained in a pressure vessel not shown in FIG. 1 and, at the start of a quench operation, admitted into the quench volume 62 or the recirculation conduit 64.

In an appropriate embodiment, the quench apparatus 6 is equipped with one or more infrared sensors 65. The at least one infrared sensor 65 takes the form of a pyrometer or infrared camera. The infrared sensor 65 is disposed in the quench chamber 61 such that its field of view covers a spatial region of the quench volume 62 in which, in the case of routine use of the quench apparatus 6, there is at least a portion of a workpiece 11 or of a reference body (not shown in FIG. 1) composed of a metallic material.

In an appropriate embodiment, the quench apparatus 6 is equipped with one or more infrared lamps 66. The at least one infrared lamp 66 is connected to an electrical power supply controllable by closed-loop control. Infrared lamps suitable for the purposes of the invention, including voltage supplies controllable by closed-loop control, are commercially available from companies including Heraeus Noblelight (https://www.heraeus.com/) and Ushio (https://www.ushio.eu/).

In an appropriate embodiment, the quench apparatus 6 comprises an electrically heatable reservoir vessel 67 for a heat fluid, such as water or air in particular. An outlet of the reservoir vessel 67 is connected via a valve 68 under electrical closed-loop control to an inlet of the recirculation conduit 64 or of the quench chamber 61.

FIG. 2 is a partial perspective view of a quench chamber with two batch carriers (10A, 10B) disposed therein, with workpieces or gears 11. Walls 61A of the quench chamber have been equipped with projections or rails 61B for mounting of the batch carriers (10A, 10B). The lower batch carrier 10A is shown in a temporary position that illustrates the loading or unloading operation. Moreover, FIG. 2 shows two tempering bodies (12A, 12B) made of a metallic material, graphite or carbon fiber-reinforced graphite (CFC). The tempering bodies 12A and 12B respectively have circular and hexagonal recesses, in each of which a workpiece 11 is disposed. On a vertical z axis indicated by the arrow 110, the tempering bodies (12A, 12B) have a dimension or height H greater than/equal to a corresponding height of the workpieces 11. The tempering bodies (12A, 12B), by comparison with the workpieces 11, have a higher emission level ε and therefore release heat to the workpieces 11 in the form of infrared radiation. In this way, after the quenching with cooling fluid has ended, the temperature of the workpieces 11 is kept virtually constant over a period of 1 to 3 minutes.

FIG. 3 shows a partial perspective view of another embodiment of the invention of a quench chamber equipped with infrared lamps 66. The other reference numerals in FIG. 3 have the same meaning as in FIG. 2. In an appropriate embodiment, each infrared lamp 66 is equipped with a reflector 66A. The reflector 66A concentrates the infrared radiation emitted by the infrared lamp 66 in an angle range about a preferential axis. The intensity of the infrared radiation as a function of its direction or its angle relative to the preferential axis is typically referred to as directional characteristic (see FIG. 4). The directional characteristic can be matched to specifications relating to the system within wide limits by the shaping of the reflectors 66A.

FIG. 4 shows a polar diagram of the directional characteristic of a typical infrared lamp with integrated reflector. In this diagram, a distance R between an origin O and a point on the solid curve is proportional to the intensity of the infrared radiation. An angle between the line R and the axis identified as “0°” corresponds to an emission angle of the infrared radiation relative to a reference axis of the infrared lamp.

FIG. 5 shows a partial perspective view of a quench chamber equipped with infrared reflectors 61C. Walls 61A of the quench chamber are equipped with projections or rails 61B for mounting of batch carriers (10A, 10B) with workpieces or gears 11 disposed thereon. In an appropriate embodiment, the infrared reflectors 61C consist of aluminum plates having a thickness of 0.5 to 5 mm. A surface of the aluminum plates remote from the walls 61C is reflective and has an emission level ε with ε≤0.1 and preferably ε≤0.05. In a further appropriate embodiment, the infrared reflectors 61C take the form of glass panes of the “low emissivity” or “low-e” type. Such glass panes are commercially available from various suppliers, for example Nippon Sheet Glass Co. Ltd. (https://www.pilkington.com/en/global/residential-applications/types-of-glass/energy-efficient-glass/low-emissivity-glass). For mounting of the infrared reflectors 61C, the wall 61A is equipped with pairs of grooves in a mutually opposite arrangement. Edges of the infrared reflectors 61C mesh into the grooves. After prolonged use of the infrared reflectors 61C, it may be necessary to remove surface contamination that reduces reflectivity and increases the emission level a. For this purpose, at least one end face of each groove is open, such that the infrared reflectors 61C can be removed from the grooves and cleaned or exchanged if required. For the purpose of illustration, FIG. 5 shows two of the infrared reflectors 61C in a partly extracted position. The other reference numerals in FIG. 5 have the same meaning as described above in connection with FIGS. 2 and 3.

FIG. 6 shows perspective views of cuboidal tempering bodies 12 with terminal box joints. The box joints enable—in the manner of a construction kit—terminal interdigitation of two tempering 12 in each case. An angle between the longitudinal axes of two mutually interdigitated tempering bodies 12 is adjustable here within a wide range. With the tempering bodies shown in FIG. 6, it is possible to divide the footprint area available for a batch carrier flexibly into regions with an outline matched to the shape of each workpiece. The terminal interdigitation improves mechanical stability and reduces the risk that the tempering bodies 12 will move and, in unfavorable cases, fall over in the course of handling of the batch carriers and of the quenching/overflow of cooling fluid.

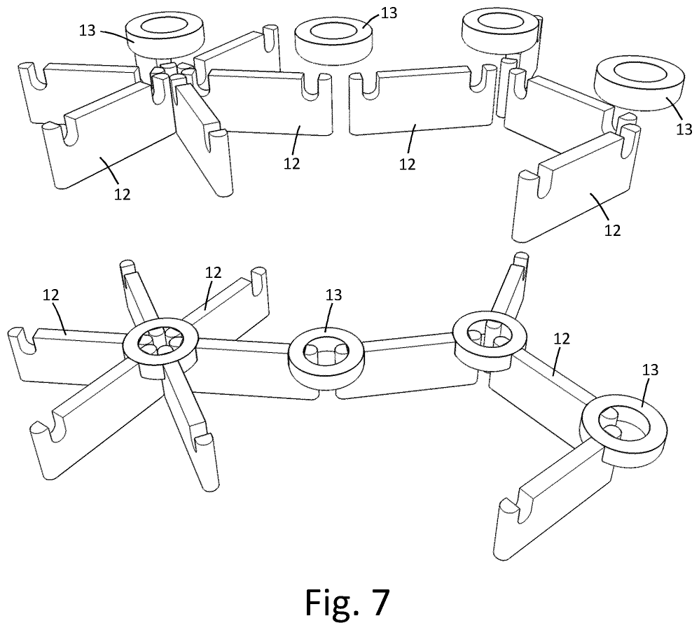

FIG. 7 shows two perspective views of a further appropriate system with first and second tempering bodies 12 and 13 respectively, which can be coupled mechanically to one another in a flexible manner. In this case, the first tempering bodies 12 are essentially cuboidal and are each provided with a slot close to their two terminal ends. The terminal slots are intended for form-fitting accommodation of the second annular tempering bodies 13.

FIG. 8 shows a schematic view of a quench apparatus 6 with a controller 20. As set out above in association with FIG. 1, the quench apparatus 6 comprises a quench 61, chamber a recirculation conduit 64 and a fan or turbine 63 for a cooling fluid to flow over workpieces 11 disposed on the batch carriers 10, and one or more infrared sensor 65 and one or more infrared lamps 66.

The controller 20 takes the form of a programmable logic controller (PLC) or computer-implemented controller (software-based PLC) and comprises a voltage supply 21, a processor 22, electronic memory 23 with a control program stored therein, electrical inputs 24 and electrical outputs 25.

The fan or turbine 63 and the infrared lamps 66 each comprise an electrical power supply under electronic closed-loop control. An electronic input of each of the above power supplies which is intended for closed-loop control of power is connected via a wire 30 to an output 25 of the controller 20. The at least one infrared sensor 65 comprises an electrical output connected via a wire 30 to an input 24 of the controller.

In appropriate embodiments (not shown in FIG. 8), further components of the system of the invention, such as the furnace, the closure devices and the transfer chamber, are connected to the controller.

1. A method of austempering metallic workpieces, comprising the steps of:
arranging the workpieces on a batch carrier;
optionally arranging one or more tempering bodies on the batch carrier;
optionally arranging a metallic reference body on the batch carrier;
thermally or thermochemically treating the workpieces arranged on the batch carrier and optionally the tempering bodies and/or the reference body, where the workpieces are heated to a temperature of 750 to 1100° C.;
arranging the batch carrier together with the workpieces and optionally the tempering bodies and/or the reference body in a quench volume V of a quench apparatus;
quenching the workpieces and optionally the tempering bodies and/or the reference body, where
(a) a cooling fluid is allowed to flow through the quench volume V, and
(b) the workpieces are tempered
with thermal radiation from the tempering bodies,
with radiation from one or more heating elements disposed in the quench apparatus, or
with a heating fluid;
wherein an average temperature T(t) of the workpieces has a progression against time according to the relationship
$$T ( t ) = {T}_{0} + {T}_{1} [ 1 + tanh ( - \frac{t}{τ} ) ]$$
where t denotes time in seconds, 150° C.≤T₀≤250° C., 600° C.≤T₁≤820° C., 12 s≤τ≤24 s, 0 s≤t≤Γ and 180 s≤Γ≤240 s.

2. The method as claimed in claim 1, wherein the cooling fluid used is air, nitrogen, helium or hydrogen.

3. The method as claimed in claim 1, wherein a pressure of the cooling fluid in the quench volume Vis 2 to 20 bar.

4. The method as claimed in claim 1, wherein the heating fluid is steam at a temperature of 150 to 250° C.

5. The method as claimed in claim 1, wherein the method further comprises measuring an average temperature T(t) of the workpieces or a temperature of the reference body during quenching.

6. The method as claimed in claim 1, wherein the method further comprises controlling the volume flow rate (m³/s) of the cooling fluid through the quench volume V by electronic closed-loop control.

7. The method as claimed in claim 1, wherein the method further comprises subjecting the power (kW) of the at least one heating element to electronic closed-loop control.

8. The method as claimed in claim 1, wherein the method further comprises subjecting the volume flow rate (m³/s) of the heating fluid in the quench volume V to electronic closed-loop control.

9. The method as claimed in claim 1, wherein the quench volume V has a size of 0.03 to 1 m³.

10. A system for austempering metallic workpieces, comprising:
one or more batch carriers for the storage of workpieces;
optionally one or more tempering bodies composed of a metallic material, graphite or carbon fiber-reinforced graphite (CFC);
optionally a reference body composed of a metallic material;
a furnace for the thermal or thermochemical treatment of workpieces disposed on one or more batch carriers and optionally tempering bodies and/or the reference body, where the furnace is designed and set up to heat the workpieces up to a temperature of 750 to 1100° C.; and
a quench apparatus comprising
a quench chamber having a quench volume V for accommodation of one or more batch carriers comprising workpieces and optionally tempering bodies and/or the reference body;
a vessel for cooling fluid and a fluid drive controllable by electronic closed-loop control for the flow of cooling fluid through the quench volume V;
one or more temperature sensors for the measurement of a temperature T(t) of the workpieces or a temperature of the reference body;
optionally one or more heating elements controllable by electronic closed-loop control;
optionally an electrically heatable vessel for a heat fluid and a valve controllable by electronic closed-loop control and/or a flow drive controllable by electronic closed-loop control for the charging of the workpieces with heat fluid; and
an electronic controller having a control program, where the fluid drive for the cooling fluid, the temperature sensors, the optional heating elements, the optional valve and the optional flow drive for the heat fluid are connected to the electronic controller;
wherein the quench apparatus is designed and set up to cool down the workpieces such that an average temperature T(t) of the workpieces has a progression against time according to the relationship
$$T ( t ) = {T}_{0} + {T}_{1} [ 1 + tanh ( - \frac{t}{τ} ) ]$$
where t denotes time in seconds, 150° C.≤T₀≤250° C., 600° C.≤T₁≤820° C., 12 s≤τ≤24 s, 0 s≤t≤Γ and 180 s≤Γ≤240 s.

11. The system as claimed in claim 10, wherein said system comprises one or more tempering bodies, and the at least one tempering body
takes the form of a cylinder or cuboid;
takes the form of a tube having a circular or rectangular opening cross section;
takes the form of a box having a multitude of compartments in shaft form for the accommodation of workpieces; or
takes the form of a box having a base plate and four side walls and comprises multiple movable dividing walls.

12. The system as claimed in claim 10, wherein the at least one heating element takes the form of an infrared lamp.

13. The system as claimed in claim 10, wherein the quench apparatus is equipped with an infrared sensor or pyrometer, and a viewing field of the infrared sensor comprises a defined region of the quench volume V and a batch carrier disposed therein.

14. The system as claimed in claim 10, wherein the quench apparatus is equipped with an infrared camera for the measurement of the temperature of the workpieces.

15. The system as claimed in claim 10, wherein the control program is designed and set up to control the fluid drive for the cooling fluid, the heating elements, the valve and/or the flow drive for the heat fluid depending on an average temperature of the workpieces or a temperature of a metallic reference body according to a closed-loop control algorithm.
